(19) United States
(12) Patent Application Publication
(10) Pub. No.: US 2010/0298609 A1
(43) Pub. Date: Nov. 25, 2010

(54) METHOD FOR PREPARING AN AROMATIC BORON REAGENT THROUGH BARBIER-TYPE REACTION

(75) Inventors: Shih-Yuan Lee, Taipei (TW); Shu-Fang Chu, Yilan City (TW); Yu-Ting Chang, Sanchong City (TW)

Correspondence Address: SCHMEISER, OLSEN & WATTS, 22 CENTURY HILL DRIVE, SUITE 302, LATHAM, NY, 12110, US

(73) Assignee: TAMKANG UNIVERSITY, Tamsui (TW)

(21) Appl. No.: 12/844,241

(22) Filed: Jul. 27, 2010

Related U.S. Application Data
(62) Division of application No. 12/468,132, filed on May 19, 2009.

(51) Int. Cl. C07F 5/04

(52) U.S. Cl. 568/6

(57) ABSTRACT

The present invention discloses a method for preparing an aromatic boron reagent through Barbier-type reaction, comprising reacting an aromatic halogen compound with a boron compound in the presence of a metal to obtain an aromatic boron reagent, wherein the metal may be or may not be activated by an activator. The method according to the present invention can avoid using expensive and complicated procedures of prior art and hence is efficient and economic.

This divisional application claims priority to U.S. application Ser. No. 12/468,132 filed on May 19, 2009, the entire disclosure of which is incorporated herein by reference. The present invention provides a method for preparing an aromatic boron reagent from an aromatic halogen compound, especially a method for preparing an aromatic boron reagent from an aromatic halogen compound through a Barbier-type reaction.

### FIELD OF THE INVENTION

### Background of the Invention

Organic metal chemistry has been developed for more than one hundred years. The organic metal compound which was first used in chemical synthesis is a zinc enolate, which was prepared by Schorigin and Schlenk through reacting an α-bromoester with zinc. Thereafter, Barbier and Grignard conducted a series of researches related to organic magnesium compounds and finally developed “Grignard reagent”, which has become well-known in the art. Both Grignard reagent and zinc enolates have the advantages of easy preparation and high reactivity, which makes these organic metal compounds become important reagents in organic synthesis.

The development of these organic metal compounds creates a new pathway for aromatic halogen compounds to form a C—C bond. It has been found from the results of lots of researches that palladium can catalyze formation of a new C—C bond between an organic halogen compound and an organic metal compound by a coupling reaction, wherein the organic metal compounds include organic zinc compounds, organic tin compounds, organic silicon compounds, organic boron compounds etc. Therefore, the coupling reaction catalyzed by a Pd or similar metal become an important research direction in organic chemical synthesis involved in formation of a C—C bond between an aromatic halogen compound and an organic metal compound. Among the aforesaid organic metal compounds, organic boron compounds, like most of other organic metal compounds, have high reactivity; in addition, the coupling reaction between the organic boron compound and the organic halogen compound has high yield. Furthermore, the organic boron compound has the following advantages: its C—B bond is stable in water; it is friendly to the environment; and it is easily separated from the product. Therefore, organic boron reagents consisting of such organic boron compounds have high utilization value in chemical synthesis. It has been reported that the organic boron compounds can be reacted with an aromatic halogen compound in an alkaline medium in the presence of a Pd metal (as catalyst), such that a new C—C bond between these two compounds is formed through coupling reaction, and a biaryl compound is obtained (as shown in the following reaction schemes (1) to (3)). The organic boron compounds suitable for use in the coupling reaction include borane compounds, boronic acid compounds, boronate ester compounds etc.

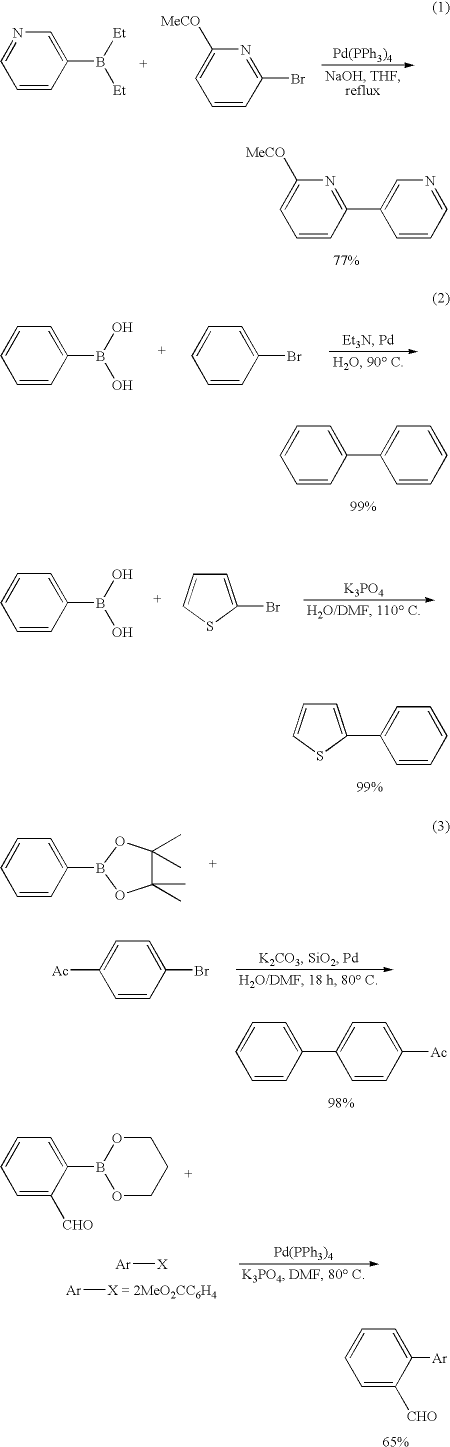

However, the conventional methods for preparing organic boron reagents have higher process cost and more complicated purification procedures when compared with the methods for preparing other organic metal compounds. In order to resolve the above problems of the conventional methods, the present inventor proposes a new method for preparing an organic boron reagent, which comprises preparing an aromatic boron reagent from an aromatic halogen compound through a Barbier-type reaction.

### SUMMARY OF INVENTION

In order to resolve the problems of prior art, the present invention provides a method for preparing an aromatic boron reagent by subjecting an aromatic halogen compound and a boron compound to a Barbier reaction in the presence of a metal at room temperature, wherein the metal may be optionally activated. The method according to the present invention can efficiently synthesize the aromatic boron reagent in a high yield and can simplify the synthetic procedures, thus lowering the production cost.

The metal-activated Barbier reaction has been used in chemical synthesis since a long time ago. Different from the conventional Grignard reaction, Barbier reaction is a one-step reaction wherein a halide is reacted with a carbonyl compound in the presence of a metal, such as Mg, to form an alcohol. It is considered that the mechanism of Barbier reaction may be involved in instant production of an organic metal intermediate, which is rapidly reacted with the carbonyl compound; or involved in production of a free radical intermediate, which is subjected to a single-electron transferring process (as shown in the reaction schemes (4) to (6)). Through. Barbier reaction, an alcohol can be efficiently prepared from a carbonyl compound by a one-pot reaction.

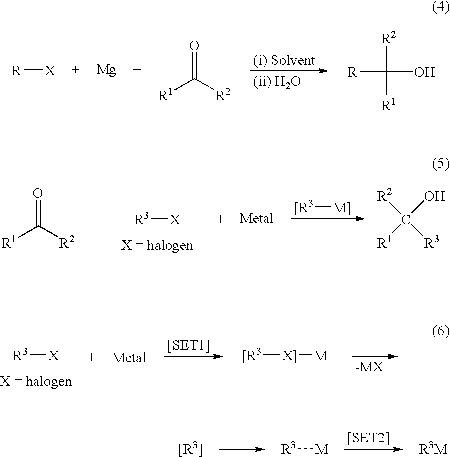

According to the method of the present invention, an aromatic halogen compound and a boron compound are subjected to a Barbier reaction in the presence of a metal, which may be optionally activated by an activator such as 1,2-dibromoethane, to form an aromatic boron reagent.

In one embodiment, the present invention provides a method for preparing an aromatic boron reagent, comprising the following steps:

dissolving an aromatic halogen compound in a solvent, then adding a metal to the solvent, such that the aromatic halogen compound is reacted with the metal (ex. Mg) in the solvent to form a Grignard reagent; reacting the Grignard reagent with a boron compound of formula (A)

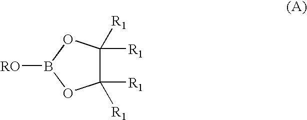

(wherein
R is methyl, ethyl, n-propyl, isopropyl, n-butyl or tert-butyl;
R₁ is H or methyl); and
extracting and purifying the resulting product to obtain the aromatic boron reagent.

In a preferred embodiment, the present invention provides a method for preparing an organic boron reagent, comprising the following steps: dissolving an aromatic halogen compound in a solvent, then adding a metal and an activator to the solvent, such that the aromatic halogen compound is reacted with the metal which has been activated by the activator in the solvent, to form a Grignard reagent; reacting the Grignard reagent with a boron compound of formula (A)

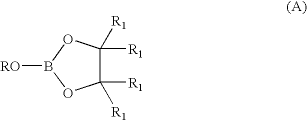

(wherein
R is methyl, ethyl, n-propyl, isopropyl, n-butyl or tert-butyl;
R₁ is H or methyl); and
extracting and purifying the resulting product to obtain the aromatic boron reagent.

The aromatic halogen compound used in the method of the present invention is selected from those having a structure of any one of formulas (B1) to (B5):

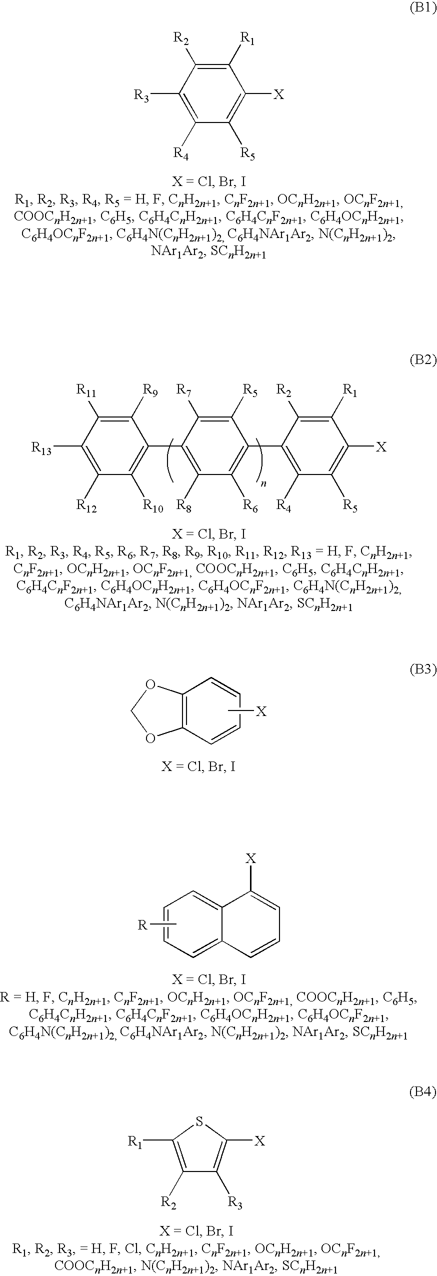

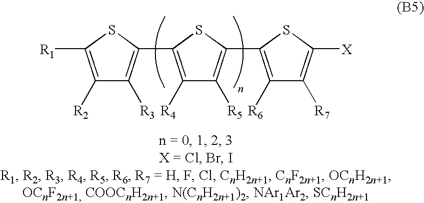

wherein n is an integer of 1 to 10.

In the preferred embodiment, the activator may be selected from 1,2-dibromoethane, 1,2-diiodoethane, iodine or Lewis acid; the metal may be selected from Mg, Li, Zn, Cu, Zn/Cu alloy. The Grignard reagent is reacted with the boron compound of formula (A) preferably for 1 to 10 hours, more preferably for 3 hours. The molar ratio of the aromatic halogen compound to the boron compound of formula (A) is preferably between 1:1 and 1:3, more preferably between 1:1 and 1:2.

Furthermore, in the preferred embodiment, the molar ratio of the aromatic halogen compound: the metal: the activator is preferably between 1:1:1 and 1:5:5, more preferably between 1:1:1 and 1:2:2. The solvent used in the method of the present invention may be selected from tetrahydrofuran (THF), ether or other similar polar organic solvents.

### DETAILED DESCRIPTION OF THE INVENTION

The present invention is further illustrated by the following Examples in reference to the appended drawings such that the objects, features and effects of the present invention can be fully understood therefrom.

### Example 1

### Preparation of an Aromatic Boron Reagent by Using Mg Metal which was not Activated

To a round-bottom flask, Mg (1.5 mmole) and an aromatic halogen compound (1.0 mmole) were added, then anhydrous tetrahydrofuran (THF, 5 ml) was injected by a syringe, and finally 2-isopropoxy-4,4,5,5-tetramethyl-1,3,2-dioxaborolane (1.5 mmole) was added. The reaction mixture was stirred at room temperature for 3 hours. After completion of reaction, the reaction mixture was filtered by suction and the filtrate was collected. The filtrate, after addition of a saturated NaCl solution (20 ml), was extracted with methylene chloride (CH₂Cl₂, 20 ml) several times. The organic layer was separated, dried over magnesium sulfate, and concentrated under reduced pressure to remove the solvent, thereby obtaining a purified product.

The aromatic halogen compound used in Example 1 was selected from those having a structure of any one of formulas (B1) to (B5):

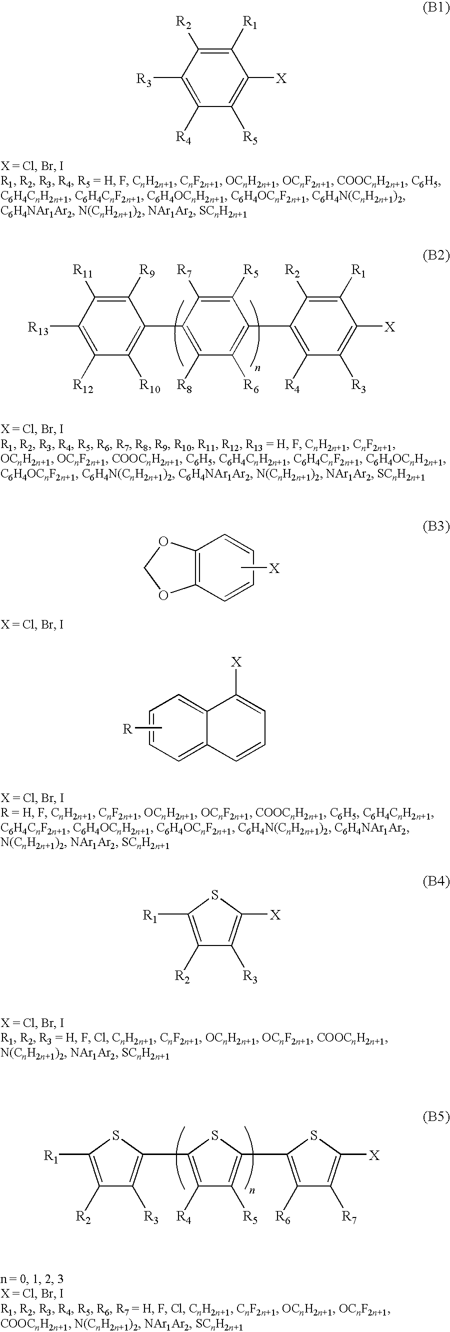

wherein n is an integer of 1 to 10.

### Example 2

### Preparation of an Aromatic Boron Reagent by Using Mg Metal which was Activated by 1,2-Dibromoethane

To a round-bottom flask, Mg metal (2.5 mmole) and an aromatic halogen compound (1.0 mmole) were added, then anhydrous tetrahydrofuran (THF, 5 ml) was injected by a syringe and 2-isopropoxy-4,4,5,5-tetramethyl-1,3,2-dioxaborolane (1.5 mmole) was added. Finally, 1,2-dibromoethane (1.0 mmole) was dropped into the resulting mixture. The reaction mixture was stirred at room temperature for 3 hours. After completion of reaction, the reaction mixture was filtered by suction and the filtrate was collected. The filtrate, after addition of a saturated NaCl solution (20 ml), was extracted with methylene chloride (CH₂Cl₂, 20 ml) several times. The organic layer was separated, dried over magnesium sulfate, and concentrated under reduced pressure to remove the solvent, thereby obtaining a purified product.

The aromatic halogen compound used in Example 2 was selected from those having a structure of any one of formulas (B1) to (B5):

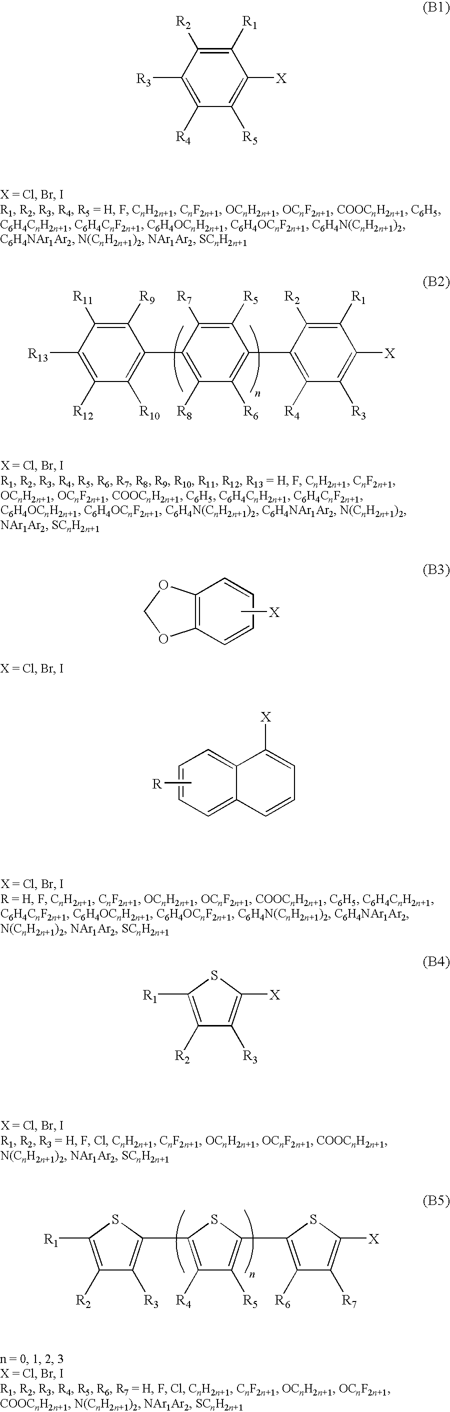

wherein n is an integer of 1 to 10.

### Example 3

### Preparation of an Aromatic Boron Reagent by Using Other Metals which were not Activated

The procedures of Example 1 were repeated except replacing the Mg metal with other metals such as Li, Zn, Cu, Cu/Zn alloy etc.

### Example 4

### Preparation of an Aromatic Boron Reagent by Using Other Metals which were Activated by 1,2-Dibromoethane

The procedures of Example 2 were repeated except replacing the Mg metal with other metals such as Li, Zn, Cu, Cu/Zn alloy etc.

### Example 5

### Preparation of an Aromatic Boron Reagent by Using a Mg Metal which was Activated by 1,2-Dibromethane

The procedures of Example 2 were repeated except the molar ratio of the aromatic halogen compound: the boron compound: the activator was changed to 1:1:1.

### Example 6

### Preparation of an Aromatic Boron Reagent by Using a Mg Metal which was Activated by 1,2-Dibromoethane

The procedures of Example 2 were repeated except the molar ratio of the aromatic halogen compound: the boron compound: the activator was changed to 1:5:5.

### Example 7

### Preparation of an Aromatic Boron Reagent by Using a Metal which was Activated by Other Activators

The procedures of Example 2 were repeated except that 1,2-dibomomethane was replaced with other activators such as 1,2-diiodoethane, iodine, Lewis acid etc; the metal was selected from Mg, Li, Zn, Cu or Cu/Zn alloy; ether, instead of tetrahydrofuran, was used as solvent.

The NMR data of the products obtained in the above Examples are as follow:

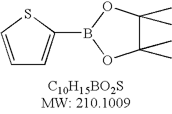

¹H-NMR (300 MHz, CDCl₃): δ1.34 (12H, s), δ7.2 (1H, dd, J=3.43, 4.67), δ7.66 (2H, ddd,

J=0.7, 3.4, 10); ¹³C-NMR (75.5 MHz, CDCl₃): δ25.0, δ84.1, δ128.4, δ132.5, δ137.2; IR(Neat): 3005(m), 2988(m), 1275(s), 1260(s), 1140(s)

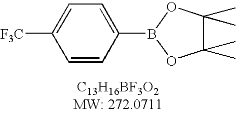

¹H-NMR (300 MHz, CDCl₃): δ1.35 (12H,s), δ 7.61 (2H, d, J=8.19), δ7.91 (2H, d, J=7.99); ¹³C-NMR (75.5 MHz, CDCl₃): δ 25.1, δ 84.5, δ 124.5, δ 135.2; IR(Neat): 2982(w), 1364(s), 1128(s)

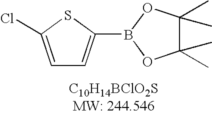

¹H-NMR (300 MHz, CDCl₃): δ1.35 (12H, s), δ 6.97 (1H, d, J=3.75), δ 7.41 (1H, d, J=3.7); ¹³C-NMR (75.5 MHz, CDCl₃): δ24.9, δ 84.5, δ127.8, δ136.9; IR(Neat): 3005(m), 2989(m), 1276(s), 1260(s), 1141(m)

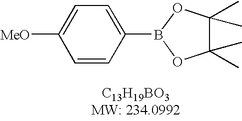

¹H-NMR (300 MHz, CDCl₃): δ1.34 (12H, s), δ3.82 (3H, s), δ6.9 (2H, d, J=8.8), δ7.78 (2H, d, J=8.7); ¹³C-NMR (75.5 MHz, CDCl₃): δ25.2, δ55.4, δ83.6, δ113.4, δ136.6, δ162.2; IR(Neat): 3005(m), 2988(m), 1275(s), 1260(s), 114(m)

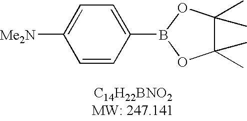

¹H-NMR (300 MHz, CDCl₃): δ1.34 (12H, s), δ2.99 (3H, s), δ 6.70 (2H, d, J=8.7), δ7.71 (2H, d, J=8.9); ¹³C-NMR (75.5 MHz, CDCl₃): δ 25.0, δ40.2, δ83.3, δ111.5, δ136.3, δ152.7; IR(Neat): 2978(w), 1356(s), 1314(s), 1140(s)

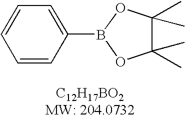

¹H-NMR (300 MHz, CDCl₃): δ1.35 (12H,s), δ7.34-7.45 (3H, m), δ7.8 (2H, dd, J=1.3, 7.8); ¹³C-NMR (75.5 MHz, CDCl₃): δ25.1, δ83.9, δ127.9, δ131.4, δ134.9; IR(Neat): 2980(m), 1357(s), 1143(s)

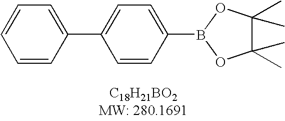

¹H-NMR (300 MHz, CDCl₃): δ 1.36 (12H,s), δ 7.36 (1H, d, J=7.1), δ 7.44 (2H, t, J=7.4), δ 7.59-7.63 (4H, m), δ7.9 (2H, d, J=8.3); ¹³C-NMR (75.5 MHz, CDCl₃): δ25.1, δ84.0, δ126.6, δ127.4, δ127.7, δ128.9, δ135.2, δ141.2, δ144.1; IR(Neat): 3007(m), 2991(m), 1277(s), 1262(s), 1145(m)

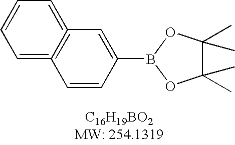

¹H-NMR (300 MHz, CDCl₃): δ1.42 (12H,s), δ7.5-7.55 (2H, m), δ 7.84-7.93 (4H, m), δ 8.42 (1H, s); ¹³C-NMR (75.5 MHz, CDCl₃): δ25.1, δ84.1, δ125.9, δ127.1, δ127.9, δ128.8, δ130.6, δ133.0, δ135.2, δ136.4; IR(Neat): 3005(m), 2987(m), 1275(s), 1260(s), 1144(m)

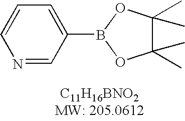

¹H-NMR (300 MHz, CDCl₃): δ1.34 (12H,s), δ7.24 (1H, m), δ7.81 (1H, m), δ8.62 (1H, dd, J=1.78, 4.8), δ8.69 (1H,s); ¹³C-NMR (75.5 MHz, CDCl₃): δ25.1, δ84.2, δ123.2, δ142.4, δ151.5, δ155.1; IR(Neat): 3005(m), 2989(m), 1275(s), 1260(s), 1143(m)

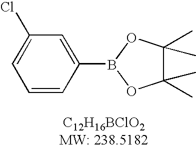

¹H-NMR (300 MHz, CDCl₃): δ1.34 (12H, s), δ7.29 (1H, m), δ7.41 (1H, m), δ7.68 (1H, m), δ7.78 (1H, s); ¹³C-NMR (75.5 MHz, CDCl₃): δ24.9, δ84.1, δ129.2, δ131.3, δ132.8, δ134.6; IR(Neat): 2980(m), 1350(s), 1142(s)

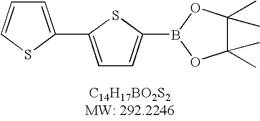

¹H-NMR (300 MHz, CDCl₃): δ1.35 (12H, s), δ 7.02 (1H, t, J=4.4), δ 7.22-7.26 (3H, m), δ7.52 (1H, d, J=3.7); ¹³C-NMR (75.5 MHz, CDCl₃): δ24.9, δ84.4, δ124.5, δ125.1, δ125.8, δ128.1, δ137.5, δ138.1, δ144.3; IR(Neat): 2977(m), 2930(m), 1344(s), 1140(s)

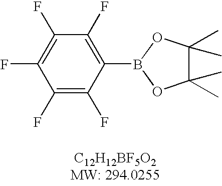

¹H-NMR (300 MHz, CDCl₃): δ1.37 (12H,s); ¹³C-NMR (75.5 MHz, CDCl₃): δ24.9, δ85.1, δ135.7, δ139.3, δ141.4, δ144.7, δ147.7, δ151.1; IR(Neat): 2984(m), 1353(s), 1140(s)

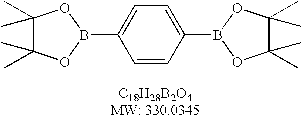

¹H-NMR (300 MHz, CDCl₃): δ1.34 (12H, s), δ7.80 (4H, s); ¹³C-NMR (75.5 MHz, CDCl₃): δ25.1, δ 84.0, δ134.1; IR(Neat): 2975(m), 2926(m), 1355(s), 1322(s), 1139(s)

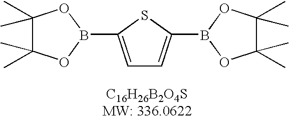

¹H-NMR (300 MHz, CDCl₃): δ1.35 (12H, s), δ7.66 (1H, s); ¹³C-NMR (75.5 MHz, CDCl₃): δ24.9, δ84.3, δ137.8; IR(Neat):3005(m), 2987(m), 1275(s), 1259(s), 1137(s)

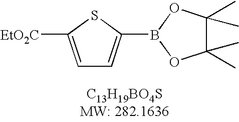

¹H-NMR (300 MHz, CDCl₃): δ1.33 (12H,s), δ1.38 (3H, t, J=7.4), δ4.34 (2H, q, J=7.1), δ7.54 (1H, d, J=3.6), δ7.80 (1H, d, J=3.6); ¹³C-NMR (75.5 MHz, CDCl₃): δ14.5, δ24.9, δ61.4, δ84.7, δ133.9, δ137.1; IR(Neat): 3005(m), 2988(m), 1275(s), 1260(s), 1139(s)

Although the preferred embodiments of the present invention have been disclosed as above; they are not considered as a limitation for the scope of present invention. Persons skilled in the art can make alterations or modification without departing from the spirit and scope of the present invention and these equivalent alterations or modification all fall within the scope of the present invention. The exact scope of the present invention is defined by the following claims.

What is claimed:

1. A method for preparing an aromatic boron reagent, comprising the following steps:
dissolving an aromatic halogen compound in a solvent, then adding a metal, together with or not together with an activator, to the solvent, such that the aromatic halogen compound is reacted with the metal in the solvent to form a Grignard reagent;
reacting the Grignard reagent with a boron compound of formula (A) 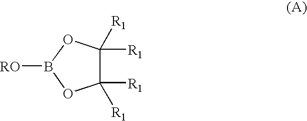
(wherein
R is methyl, ethyl, n-propyl, isopropyl, n-butyl or tert-butyl;
R₁ is H or methyl); and
extracting and purifying the resulting product to obtain the aromatic boron reagent.

2. The method for preparing an aromatic boron reagent according to claim 1, wherein the aromatic halogen compound is selected from those having a structure of formula (B4) or (B5): 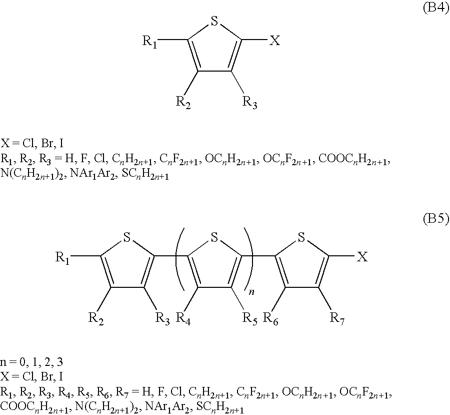
wherein n is an integer of 1 to 10.

3. The method for preparing an aromatic boron reagent according to claim 1, wherein the metal is selected from Mg, Li, Zn, Cu or Zn/Cu alloy.

4. The method for preparing an aromatic boron reagent according to claim 1, wherein the Grignard reagent is reacted with the boron compound of formula (A) for 1 to 10 hours.

5. The method for preparing an aromatic boron reagent according to claim 1, wherein the molar ratio of the aromatic halogen compound to the boron compound of formula (A) is between 1:1 and 1:3.

6. The method for preparing an aromatic boron reagent according to claim 1, wherein the molar ratio of the aromatic halogen compound to the metal is between 1:1 and 1:5.

7. The method for preparing an aromatic boron reagent according to claim 1, wherein the solvent is selected from tetrahydrofuran, ether or other similar polar organic solvents.

8. The method for preparing an aromatic boron reagent according to claim 1, wherein the activator is selected from 1,2-dibromoethane, 1,2-diiodoethane, iodine or Lewis acid.
